(19) United States
(12) Patent Application Publication
(10) Pub. No.: US 2005/0002402 A1
(43) Pub. Date: Jan. 6, 2005

(54) Real-time transport protocol

(75) Inventor: Bruce Alan Fairman, Woodside, CA (US)

Correspondence Address: Jonathan O. Owens;HAVERSTOCK & OWENS LLP, 162 North Wolfe Road, Sunnyvale, CA, 94086, US

(73) Assignee: Sony Corporation and Sony Electronics Inc.

(21) Appl. No.: 10/814,848

(22) Filed: Mar. 30, 2004

Related U.S. Application Data
(60) Provisional application No. 60/471,898, filed on May 19, 2003.

(51) Int. Cl. H04L 12/28

(52) U.S. Cl. 370/395.5

(57) ABSTRACT

A real-time transport protocol (RTP) describes a payload format for transporting IEC 61883-1 CIP compliant IEEE 1394-2000 isochronous transport data. The transport data includes a stream format, such as DV (Digital Video), AM824 (Audio/Music data format with an 8-bit header and 24 bits of audio), or MPEG, that has been packetized for isochronous transport by a source. The payload format is opaque to the transport mechanism. The isochronous transport clock is derived from the IEEE 1394-2000 cycle timer clock. The RTP is used to transport IEEE 1394-2000, IEC 61883 compliant data streams between IEEE 1394-2000 buses using IP (Internet Protocol), specifically, Ethernet/IP. Alternatively, other IP formats are used.

### RELATED APPLICATIONS

This Patent Application claims priority under 35 U.S.C. § 119(e) of the co-pending U.S. provisional application Ser. No. 60/471,898 filed on May 19, 2003 and entitled “REAL TIME TRANSPORT PROTOCOL.” The provisional application Ser. No. 60/471,898 filed on May 19, 2003 and entitled “REAL TIME TRANSPORT PROTOCOL,” is also hereby incorporated by reference.

### FIELD OF THE INVENTION

The present invention relates to the field of transmitting data using isochronous data packets. More particularly, the present invention relates to the field of performing retransmission and flow control on data transmitted using isochronous data packets.

### BACKGROUND OF THE INVENTION

A standard adopted by the Institute for Electrical and Electronics Engineers (IEEE), “IEEE 1394-2000 Standard For A High Performance Serial Bus,” is an international standard for implementing an economical high-speed serial bus architecture. This standard provides a universal input/output connection for interconnecting digital devices including, for example, audio-visual equipment and personal computers.

The IEEE 1394-2000 standard supports both asynchronous and isochronous format data transfers. Asynchronous transfers are data transfer operations which transfer data from a source node to a destination node and take place as soon as permitted after initiation. An example of an application appropriate for asynchronous data transfer is communication of a still image or text document. Control commands can also be sent asynchronously.

Isochronous data transfers are real-time data transfers which take place such that time intervals between significant instances have the same duration at both the transmitting and receiving applications. An example of an application suitable for the transfer of data isochronously is the transfer of audio-visual data (AV data) between devices, such as a video camera and a television set. The video camera records sounds and images (AV data) and stores the data in discrete segments on tape. The data payload included in each packet represents the image and/or sound recorded over a limited period of time. The video camera then transfers each segment in a packetized manner during an appropriate interval for reproduction by the television set. In this manner, a transmitted sequence of related isochronous data packets constitutes an AV program, such as a television program or a motion picture.

The IEEE 1394-2000 standard bus architecture provides multiple channels for isochronous data communication between applications. A six-bit channel number is broadcast with the data to allow reception by the appropriate application. This allows multiple applications to concurrently communicate isochronous data across the bus structure without interfering with each other.

The cable required by the IEEE 1394-2000 standard is relatively thin in size compared to other bulkier cables used to connect such devices. The IEEE 1394-2000 cable environment is a network of nodes connected by point-to-point links, each link including a port for each node's physical connection and the cable between them. The physical topology for the cable environment of an IEEE 1394-2000 serial bus is a non-cyclic network of multiple ports, with finite branches. A primary restriction on the cable environment is that nodes must be connected together without forming any closed loops.

Devices can be added and removed from an IEEE 1394-2000 bus while the bus is active. If a device is so added or removed, the bus automatically reconfigures itself for transmitting data between the then existing nodes. A node is considered a logical entity with a unique address on the bus structure. Each node provides an identification ROM, a standardized set of control registers and its own address space.

The IEEE 1394-2000 cables connect ports together on different nodes. Each port includes terminators, transceivers and logic. A node can have multiple ports at its physical connection. The cable and ports act as bus repeaters between the nodes to simulate a single logical bus. The cable physical connection at each node includes one or more ports, arbitration logic, a resynchronizer and an encoder. Each of the ports provide the cable media interface into which the cable connector is connected. The arbitration logic provides access to the bus for the node. The resynchronizer takes received data-strobe encoded data bits and generates data bits synchronized to a local clock for use by the applications within the node. The encoder takes either data being transmitted by the node or data received by the resynchronizer, which is addressed to another node, and encodes it in data-strobe format for transmission across the IEEE 1394-2000 serial bus. Using these components, the cable physical connection translates the physical point-to-point topology of the cable environment into a virtual broadcast bus, which is expected by higher layers of the system. This is accomplished by taking all data received on one port of the physical connection, resynchronizing the data to a local clock and repeating the data out of all of the other ports from the physical connection.

The IEEE 1394-2000 standard defines a protocol as illustrated in FIG. 1. This protocol includes a serial bus management block 10 coupled to a transaction layer 12, a link layer 14 and a physical layer 16. The physical layer 16 provides the electrical and mechanical connection between a device or application and the IEEE 1394-2000 cable. The physical layer 16 also provides arbitration to ensure that all devices coupled to the IEEE 1394-2000 bus have access to the bus as well as actual data transmission and reception. The link layer 14 provides data packet delivery service for both asynchronous and isochronous data packet transport. This supports both asynchronous data transport, using an acknowledgment protocol, and isochronous data transport, providing real-time guaranteed bandwidth protocol for just-in-time data delivery. The transaction layer 12 supports the commands necessary to complete asynchronous data transfers, including read, write and lock. The serial bus management block 10 contains an isochronous resource manager for managing isochronous data transfers. The serial bus management block 10 also provides overall configuration control of the serial bus in the form of optimizing arbitration timing, guarantee of adequate electrical power for all devices on the bus, assignment of the cycle master, assignment of isochronous channel and bandwidth resources and basic notification of errors.

The IEEE 1394-2000 standard defines a structured packet into which information is encapsulated for isochronous transfer upon the bus. Each isochronous data packet includes at least an IEEE 1394-2000 packet header. The packet header includes overhead information necessary for proper communication of the packet. Typically, content data, such as audio-visual data, is included in the packet, in a data field following the packet header. When an isochronous data packet is received, the receiving device must generally separate the header information from the content data so that the content data can be appropriately processed, such as for display. In addition, due to timing considerations, isochronous packets which include only header information and no content data portion are occasionally communicated via an IEEE 1394-2000 bus.

IEEE 1394-2000 isochronous data packets are transmitted over isochronous channels using isochronous arbitration or over asynchronous streams using asynchronous arbitration. Transmitting over isochronous channels, an isochronous data packet is transmitted only during the isochronous period. The isochronous period is controlled by the cycle master, which signals the start of the period with a cycle start packet. The period ends when a subaction gap is observed, which happens after all isochronous transmitters have had a chance to transmit. Two resources, bandwidth and channel number, are allocated from the isochronous resource manager registers BANDWIDTH_AVAILABLE and CHANNELS_AVAILABLE, respectively. For a given channel number, no more than one transmitter can transmit an isochronous data packet with that channel number each isochronous period.

The IEEE 1394-2000 standard does not specify particular formats for the content data of the data field. Rather, the organization of content data in accordance with a particular format and the interpretation of data field contents are functions of the transmitting and receiving applications, respectively. In order to facilitate interoperability between a wide range of digital devices, data fields should encapsulate data in accordance with a standardized format. One such format that has gained wide acceptance is the Common Isochronous Protocol (CIP) defined by IEC-61883, the ratified international standard for the transport of audio/video command requests and responses. The data field may contain a header and audio-visual content data, as when the CIP Transport Protocol is used. This header within the data field is the CIP header.

A format of a CIP header within an isochronous data packet is illustrated in FIG. 2. Within the CIP header, a SID field contains the source node ID value of the transmitting node. A DBS field contains a value representing the size of the data block in quadlets. A FN field contains a fraction number representing the number of data blocks into which a source packet is divided. A QPC field contains a value representing the number of dummy quadlets added to a source packet to equalize the size of the divided data blocks. If the FN field indicates that the source packet is not divided, then the QPC field will contain a value equal to zero. An SPH flag represents whether or not the source packet includes a source packet header. The SPH flag is set equal to a logical “one” when the source packet does include a source packet header. An RSV field is reserved for future extension. A DBC field is a continuity counter of data blocks to detect a loss of data blocks. An FMT field includes a format identifier which identifies the format of the packet. An FDF field is a format dependent field and depends on the format of the packet. An SYT field is used to synchronize the transmitter and the receiver. When transmitting isochronous data over an IEEE 1394-2000 serial bus network, the SYT field may contain a time stamp value for the presentation time of the frame. The receiving node uses this time stamp value to ensure that the data is presented within the correct boundary of time for video data.

For CIP transport, some data fields contain only the CIP header. This use of a header and data protocol within the data field is referred to as an Isochronous Transport Protocol. A receiver of such isochronous packets cannot necessarily predict when a packet will not include a content data portion until after the IEEE 1394-2000 header information is received.

### SUMMARY OF THE INVENTION

A real-time transport protocol (RTP) describes a payload format for transporting IEC 61883-1 CIP compliant IEEE 1394-2000 isochronous transport data. The transport data includes a stream format, such as DV (Digital Video), AM824 (Audio/Music data format with an 8-bit header and 24 bits of audio), or MPEG, that has been packetized for isochronous transport by a source. The payload format is opaque to the transport mechanism. The isochronous transport clock is derived from the IEEE 1394-2000 cycle timer clock. The RTP is used to transport IEEE 1394-2000, IEC 61883 compliant data streams between IEEE 1394-2000 buses using IP (Internet Protocol), specifically, Ethernet/IP. Alternatively, other IP formats are used.

A method of communicating data streams includes packetizing one or more data streams into isochronous data packets, encapsulating one or more isochronous data packets according to a real-time transport protocol to form a real-time transport protocol data packet, and sending the real-time transport protocol data packets from a transmitting device to a receiving device over a non-isochronous compliant network. The transmitting device is coupled to a first isochronous compliant network and the receiving device is coupled to a second isochronous compliant network. The first isochronous compliant network and the second isochronous compliant network each comprise an IEEE 1394 compliant bus architecture. The first isochronous compliant network and the second isochronous compliant network are coupled via the non-isochronous compliant network. The non-isochronous compliant network comprises an Internet Protocol network. The Internet Protocol network comprises an Ethernet/Internet Protocol network. The method also includes generating a cycle record for each isochronous cycle of the first isochronous compliant network, wherein each cycle record includes a relative timing marker that indicates a timing of the real-time transport protocol data packet relative to the cycle master of the first isochronous compliant network. The real-time transport protocol defines a real-time transport protocol header and a real-time transport protocol data payload for each real-time transport protocol data packet. The real-time transport protocol data payload comprises one or more isochronous cycle records. Each of the one or more cycle records comprises zero or more isochronous data packets. Each isochronous data packet comprises an IEEE 1394 isochronous data packet. Each IEEE 1394 isochronous data packet includes an IEEE 1394 data payload formatted according to an IEC 61883-1 compliant Common Isochronous Protocol (CIP). The real-time transport protocol header includes a timestamp, the timestamp is defined by a value of the isochronous cycle start transaction corresponding to the receipt of a first isochronous data packet included in a particular real-time transport protocol data packet.

An apparatus to communicate data streams includes a transmitting circuit configured to encapsulate one or more first isochronous data packets according to a real-time transport protocol, thereby forming a first real-time transport protocol data packet, and to transmit the first real-time transport protocol data packets over a non-isochronous compliant network, and a receiving circuit configured to receive a second real-time transport protocol data packet from the non-isochronous compliant network, and to de-encapsulate the received second real-time transport protocol data packets into one or more second isochronous data packets. The transmitting circuit and the receiving circuit are each coupled to an isochronous compliant network. The isochronous compliant network comprises an IEEE 1394 compliant bus architecture. The real-time transport protocol defines a real-time transport protocol header and a real-time transport protocol data payload for each real-time transport protocol data packet. The real-time transport protocol data payload comprises one or more isochronous cycle records. Each of the one or more isochronous cycle records comprises zero or more isochronous data packets. Each isochronous data packet comprises an IEEE 1394 isochronous data packet. Each IEEE 1394 isochronous data packet includes an IEEE 1394 data payload formatted according to an IEC 61883-1 compliant Common Isochronous Protocol (CIP). The real-time transport protocol header includes a timestamp, the timestamp is defined by a value of the isochronous cycle start transaction corresponding to the receipt of a first isochronous data packet included in a particular real-time transport protocol data packet. The transmitting circuit is further configured to packetize one or more data streams into the one or more isochronous data packets. The transmitting circuit is further configured to receive the one or more isochronous data packets from another device. The receiving circuit is further configured to parse the one or more isochronous data packets from each received real-time transport protocol data packet. Each received real-time transport protocol data packet includes at least a portion of an isochronous cycle record. Each isochronous cycle record comprises zero or more isochronous data packets.

A network of devices to communicate data streams includes a transmitting device configured to encapsulate one or more isochronous data packets according to a real-time transport protocol, thereby forming a real-time transport protocol data packet, and to transmit the real-time transport protocol data packets, a first isochronous compliant network coupled to the transmitting device, a receiving device configured to receive the real-time transport protocol data packets, a second isochronous compliant network coupled to the receiving device, and a non-isochronous compliant network coupled to the first isochronous compliant network and the second isochronous compliant network to transmit the real-time transport protocol data packets from the transmitting device to the receiving device. The first isochronous compliant network and the second isochronous compliant network each comprise an IEEE 1394 compliant bus architecture. The non-isochronous compliant network comprises an Internet Protocol network. The Internet Protocol network comprises an Ethernet/Internet Protocol network. The real-time transport protocol defines a real-time transport protocol header and a real-time transport protocol data payload for each real-time transport protocol data packet. The real-time transport protocol data payload comprises one or more isochronous cycle records. Each of the one or more cycle records comprises zero or more isochronous data packets. Each isochronous data packet comprises an IEEE 1394 isochronous data packet. Each IEEE 1394 isochronous data packet includes an IEEE 1394 data payload formatted according to an IEC 61883-1 compliant Common Isochronous Protocol (CIP). The real-time transport protocol header includes a timestamp, the timestamp is defined by a value of the isochronous cycle start transaction corresponding to the receipt of a first isochronous data packet included in a particular real-time transport protocol data packet. The transmitting device is further configured to packetize one or more data streams into the one or more isochronous data packets. The transmitting device is further configured to receive the one or more isochronous data packets from another device. The receiving device is further configured to parse the one or more isochronous data packets from each received real-time transport protocol data packet. Each received real-time transport protocol data packet includes at least a portion of an isochronous cycle record. Each isochronous cycle record comprises zero or more isochronous data packets.

A method of communicating data streams includes packetizing one or more data streams into IEEE 1394 compliant isochronous data packets, encapsulating one or more IEEE 1394 compliant isochronous data packets according to a real-time transport protocol to form a real-time transport protocol data packet, and sending the real-time transport protocol data packets from a transmitting device to a receiving device over a non-isochronous compliant network. The transmitting device is coupled to a first IEEE 1394 compliant bus architecture and the receiving device is coupled to a second IEEE 1394 compliant bus architecture. The non-isochronous compliant network comprises an Internet Protocol network. The Internet Protocol network comprises an Ethernet/Internet Protocol network. The method also includes generating a cycle record for each isochronous cycle of the first IEEE 1394 compliant bus architecture, wherein each cycle record includes a relative timing marker that indicates a timing of the real-time transport protocol data packet relative to the cycle master of the first IEEE 1394 compliant bus architecture. The real-time transport protocol defines a real-time transport protocol header and a real-time transport protocol data payload for each real-time transport protocol data packet. The real-time transport protocol data payload comprises one or more 1394 compliant isochronous cycle records. Each of the one or more isochronous cycle records comprises zero or more isochronous data packets. Each IEEE 1394 isochronous data packet includes an IEEE 1394 data payload formatted according to an IEC 61883-1 compliant Common Isochronous Protocol (CIP). The real-time transport protocol header includes a timestamp, the timestamp is defined by a value of the isochronous cycle start transaction corresponding to the receipt of a first 1394 compliant isochronous data packet included in a particular real-time transport protocol data packet. The method also includes parsing the one or more IEEE 1394 compliant isochronous data packets from each real-time transport protocol data packet received by the receiving device.

### BRIEF DESCRIPTION OF THE DRAWINGS

FIG. 1 illustrates a protocol according to the IEEE 1394-2000 standard.

FIG. 2 illustrates a format of a CIP header within an isochronous data packet.

FIG. 3 illustrates an exemplary network for communicating isochronous data packets over a non-isochronous compliant network according to a real-time transport protocol.

FIG. 4 illustrates a block diagram of an exemplary network device from the exemplary network of FIG. 3.

FIG. 5 illustrates an IEEE 1394-2000 cycle timer.

FIG. 6 illustrates a first embodiment of a real-time transfer protocol (RTP) packet format for an IEC 61883-1 isochronous data stream.

FIG. 7 illustrates a first embodiment of an isochronous data packet format.

FIG. 8 illustrates a first embodiment of a record for a particular isochronous cycle.

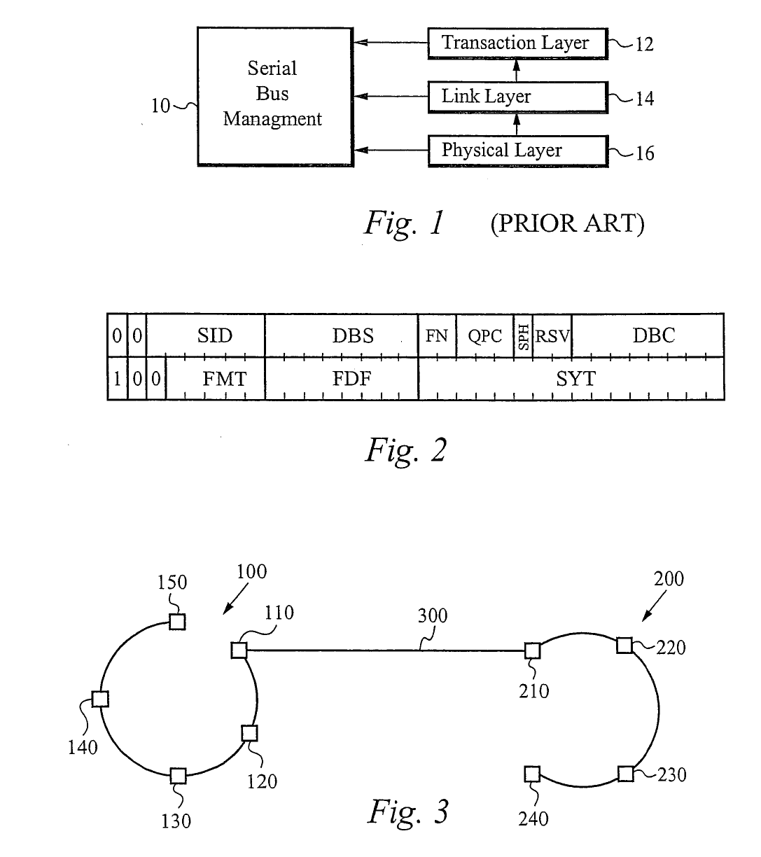

### DETAILED DESCRIPTION OF THE PREFERRED EMBODIMENT

A real-time transport protocol (RTP) describes a payload format for transporting IEC 61883-1 CIP compliant IEEE 1394-2000 isochronous transport data. The transport data includes a stream format, such as DV (Digital Video), AM824 (Audio/Music data format with an 8-bit header and 24 bits of audio), or MPEG, that has been packetized for isochronous transport by a source. The payload format is opaque to the transport mechanism. The isochronous transport clock is derived from the IEEE 1394-2000 cycle timer clock. The RTP is used to transport IEEE 1394-2000, IEC 61883 compliant data streams between IEEE 1394-2000 buses using IP (Internet Protocol), specifically, Ethernet/IP. Alternatively, other IP formats are used.

FIG. 3 illustrates an exemplary network for communicating isochronous data packets over a non-isochronous compliant network according to a real-time transport protocol. A first network 100 is an isochronous compliant network, including network devices 110, 120, 130, 140, and 150. In a first embodiment, the first isochronous compliant network 100 is an IEEE 1394-2000 serial bus architecture. A second network 200 is an isochronous compliant network including network devices 210, 220, 230, and 240. In the first embodiment, the second isochronous compliant network 200 is an IEEE 1394-2000 serial bus architecture. The first isochronous compliant network 100 and the second isochronous compliant network 200 are coupled together via a non-isochronous compliant network 300. In the first embodiment, the non-isochronous compliant network 300 is an Internet Protocol (IP) network. In the first embodiment, the IP network is an Ethernet/IP network. In the first embodiment, the first isochronous compliant network 100 is coupled to the non-isochronous network 300 via network device 110, and the second isochronous compliant network 200 is coupled to the non-isochronous compliant network 300 via network device 210. It is understood that the network illustrated in FIG. 3 is for illustrative purposes only, and that more or less network devices, isochronous compliant networks and non-isochronous compliant networks can be included than those shown in FIG. 3.

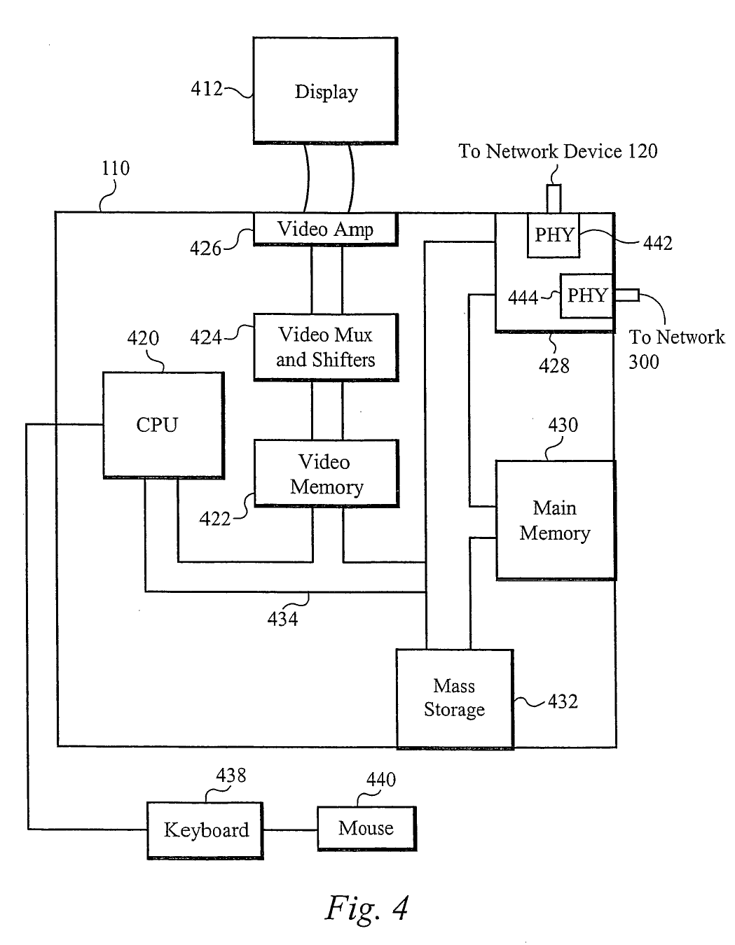

FIG. 4 illustrates a block diagram of an exemplary network device from the network of devices illustrated in FIG. 3. Specifically, FIG. 4 illustrates a block diagram of internal components of the network device 110 illustrated in FIG. 3. The network device 110 includes a central processor unit (CPU) 420, a main memory 430, a video memory 422, a mass storage device 432 and an interface circuit 428, all coupled together by a conventional bi-directional system bus 434.

The interface circuit 428 includes a physical interface circuit 442 for sending and receiving communications via an isochronous compliant network, such as an IEEE 1394-2000 serial bus. The interface circuit 428 also includes a physical interface circuit 444 for sending and receiving communications via a non-isochronous compliant network, such as Ethernet/IP. The physical interface circuit 442 is coupled to the network device 120 (FIG. 3), and the physical interface circuit 444 is coupled to the network 300. In the first embodiment, the interface circuit 428 is implemented as an IEEE 1394-2000 interface card and an Ethernet/IP interface card within the network device 110. However, it should be apparent to those skilled in the art that the interface circuit 428 is capable of being implemented within the network device 110 in any other appropriate manner, including building the interface circuit onto the motherboard itself.

The mass storage device 432 may include both fixed and removable media using any one or more of magnetic, optical or magneto-optical storage technology or any other available mass storage technology. The system bus 434 contains an address bus for addressing any portion of the memory 422, 430 and 432. The system bus 434 also includes a data bus for transferring data between and among the CPU 420, the main memory 430, the video memory 422, the mass storage device 432 and the interface circuit 428.

The network device 110 is also coupled to a number of peripheral input and output devices including a keyboard 438, a mouse 440 and the associated display 412. The keyboard 438 is coupled to the CPU 420 for allowing a user to input data and control commands into the network device 110. A conventional mouse 440 is coupled to the keyboard 438 as a cursor control device for manipulating graphic images on the display 412.

A port of the video memory 422 is coupled to a video multiplex and shifter circuit 424, which in turn is coupled to a video amplifier 426. The video amplifier 426 drives the display 412. The video multiplex and shifter circuitry 424 and the video amplifier 426 convert pixel data stored in the video memory 422 to raster signals suitable for use by the display 412.

The ability to transport IEC 61883-1 (CIP) isochronous streams, originated on IEEE 1394-2000 networks (buses), over IP networks is important for Audio/Video devices, particularly multi-media applications using digital Audio/Video devices. There are some unique characteristics of IEC 61883-1 that are addressed in order to use RTP as the transport protocol. Described herein is an RTP header and payload format for transporting IEEE 1394-2000, IEC 61883-1 isochronous data streams.

Benefits of using RTP for IEC 61883-1 isochronous stream transport include the ability to deliver IEC 61883-1 isochronous streams on distinct IEEE 1394-2000 buses. Also, a number of IEEE 1394-2000 isochronous intervals' data are capable of being transmitted in one RTP packet, based on the MTU (Maximum Transmission Unit), thereby improving the efficiency of using an IP network. Another benefit is that IP based applications have the ability to access IEEE 1394-2000 isochronous streams by implementing CIP processing of the RTP stream.

The transport of IEC 61883-1 compliant isochronous data is based on an isochronous clock at a source device that is used to packetize application data streams, for example source packets. The isochronous clock is, in turn, based on the applications' source clock. The applications' source clock is the clock of the source device running the application. In other words, the isochronous clock refers to the clock of the bus to which the source device is connected, and the application clock is the clock of the source device. The application clocks of each device are not inherently synchronized to the isochronous clock. A receiving devices' isochronous clock is synchronized with a sending devices' isochronous clock when the receiving device and the sending device are coupled to the same bus with the same cycle master. The per isochronous cycle bit rate of the isochronous packet transport is generally not constant. For the IEEE 1394-2000 bus, bandwidth is allocated based on the maximum data rate and the sending device transmits truncated or null packets such that the average data rate requirement of the application is met. Packets do not exceed the allocated bus bandwidth.

The isochronous nature of IEC 61883-1 makes RTCP (Real-time Transport Control Protocol) unnecessary since the data rate of the isochronous source is not directly adjustable. Application level protocols adjust the data rate, if needed.

Further, there is an IEC 61883-1 defined connection control method called Connection Management Procedures/Plug Control Registers (CMP/PCR). This method allows an observer to determine the state of a particular connection.

The IEEE 1394-2000 cycle master is the provider of the bus-wide clock on which the isochronous cycles are based. The cycle master function operates on an isochronous capable IEEE 1394-2000 bus. The cycle master is selected by the self-id process and is the root that controls arbitration. The PHY unit sends self-ID packets during the self-ID phase of arbitration, or when other devices on the bus send a “ping” packet. Up to three self-ID packets may be sent in response, the exact number is implementation dependent. Along with other parameters, the self-ID packet(s) include information about the maximum communication speed supported by the device, the port connection status, and power consumption characteristics. A cycle timer value is written to all nodes by a broadcast write (cycle start transaction) of the contents of the cycle master's cycle timer register when isochronous arbitration is successful. Isochronous arbitration is initiated upon the cycle count incrementing in the cycle master's cycle count. The bus cycle clock's period is derived from the PHY clock which increments the cycle timer. The tolerance of the clock is used to derive the master cycle clock. However, due to the IEEE 1394-2000 arbitration and bus occupancy mechanism, there is a maximum delay for the occurrence of a cycle start transaction. Therefore, there is a maximum delay for the recurrence of a particular stream, or channel ID. The cycle clock is used to packetize the application generated source packets, such that the bandwidth allocated for the application is not exceeded. The well-defined maximum delay allows applications to have well defined and limited buffering for IEC 61883 data streams.

In an exemplary case, the bus cycle clock's period is about 125 μsec (8 KHz). This period is derived from a 24.576 MHz PHY clock (40.690 nsec granularity) which increments the cycle timer. The tolerance of the clock used to derive the master cycle clock is ±100 PPM. The IEEE 1394-2000 arbitration and bus occupancy mechanism results in a maximum delay of approximately 78 μsec for the occurrence of a cycle start transaction. The maximum delay for the recurrence of a particular stream (channel ID) is 185.5 μs (where the channel's bandwidth is defined in μsec).

Bandwidth is allocated as time on the bus, rather than data rate per unit time. The IRM (Isochronous Resource Manager) is responsible for managing the bandwidth available register, from which bandwidth units are subtracted by nodes requiring bandwidth. Bandwidth units are measured in time units, such as 20 nsec per unit. Each cycle then consists of a determinable number of bandwidth units. In an exemplary case where each bandwidth unit equals 20 nsec per unit, there are 6144 bandwidth units per cycle, of which 4915 can be used for isochronous traffic. In this exemplary case, 1 μsec is about 49 bandwidth allocation units.

The IEEE 1394-2000 specification states that the cycle timer does not move backwards. However, this does not account for bus resets that select a new cycle master, for example when joining two buses. In this case, there will likely be a discontinuity in the cycle timer value. Such a discontinuity is not relevant to the actual timing, as long as arbitrated bus resets are used.

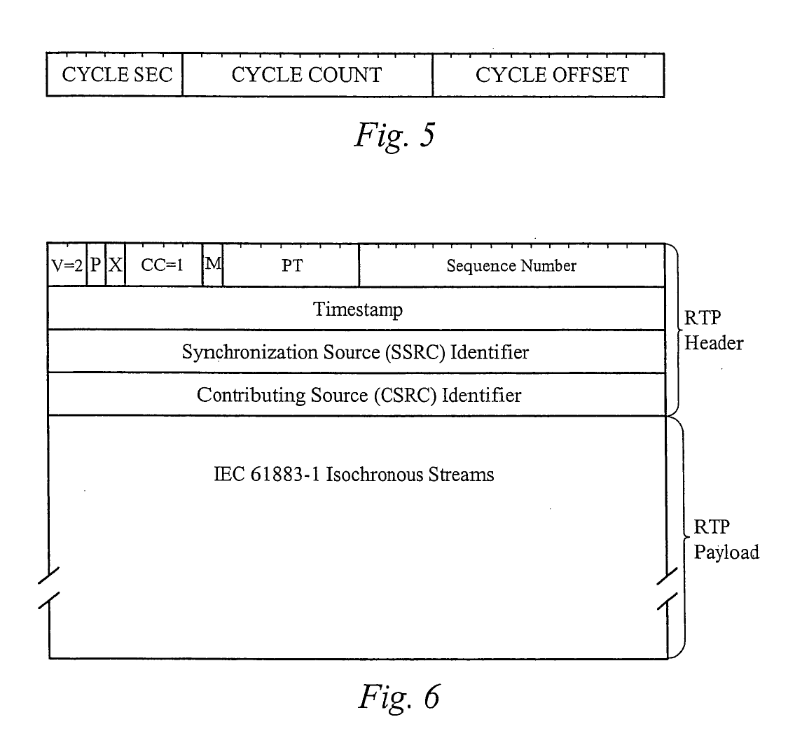

FIG. 5 illustrates an IEEE 1394-2000 cycle timer. The IEEE 1394-2000 cycle timer includes a cycle offset, a cycle count, and a cycle sec. The cycle offset is a counter incremented by PHY clock ticks. In a first embodiment, the PHY clock tick is 40.69 nsec, and the counter increments to a maximum count of 3071, such that the counter rolls over every 125 μsec. The cycle count is a counter incremented by the cycle offset rollover. In the first embodiment described above, the cycle count increments to a maximum count of 7999, such that the cycle count rolls over every 1 sec (8 KHz). The cycle sec is a counter incremented by the cycle count rollover. In the first embodiment, the cycle sec increments to a maximum count of 127, such that the cycle sec rolls over every 128 sec.

IEEE 1394-2000 arbitration can introduce jitter to the start time of an isochronous period, which corresponds to the time following the first isochronous arbitration grant. This is accommodated by the cycle master transmitting its cycle timer, which includes cycle offset, at the actual transmission of the cycle start transaction.

A IEEE 1394-2000 isochronous data packet is characterized by a header portion and a data portion. The header portion is created by first adding an IEEE 1394-2000 isochronous header according to the IEEE 1394-2000 standard. Second, an IEC 61883 CIP header according to the IEC 61883 standard is added to the header portion. The data portion is created by parsing the data stream content in sequential portions and adding a portion into the data portion according to the IEC 61883 standard.

The IEEE 1394-2000 isochronous data stream is identified by the channel number contained in its isochronous header portion. This is a unique identifier managed by the Isochronous Resource Manager (IRM) function. It is possible for a given program to occupy multiple channels. The channel number has meaning only on the particular IEEE 1394-2000 bus on which it is used. These factors lead to a need for multiple channels to be mapped into a single RTP session. Briefly, for each isochronous cycle (nominally, 125 μsec), there are zero or one occurrences of data for a given channel. The order in which channels occur in an isochronous cycle is not guaranteed. Also, packets may be shorter than the maximum allowed by the bandwidth allocated to the channel.

It is possible for a node to miss a cycle start if there is a transmission problem with the cycle start packet. However, concurrently there can be nodes on the bus that successfully receive the cycle start. This can cause a situation wherein isochronous traffic is observed without a node being in an isochronous mode. Further, the IEEE 1394-2000 bus operates with a very low error rate. However, it is still possible to have an error. For isochronous traffic, there is no retransmission, so there is a need to allow for recovery from missing cycle start packets, or missing or corrupted data packets. This will be discussed in greater detail below.

The IEC 61883 standard includes a specification for a two-quadlet CIP header. This CIP header defines two uses of a value derived from the cycle timer: the SYT field and the source packet header (SPH). The values in these fields are a function of the cycle timer on the bus where the packets exist. These fields usually relate to timing of the delivery of the ensuing data block to a receiving application. These fields are absolute values tied to the value of the cycle timer. The function which generates the value is tied to the kind of data block being transported and typically is the presentation time to the receiver application.

The SYT field contains a value derived from the lower 16 bits of the cycle timer. The SYT value derivation is from 4 bits of cycle count and 12 bits of cycle offset. The SYT field spans 16 cycles. In one embodiment, 16 cycles is approximately 2 msec. The SYT value is typically some absolute time in the future, based on the cycle timer.

The CIP header also includes an S bit, which is equivalent to the SPH bit described above in relation to FIG. 2. If the S bit=1, then the quadlet following the CIP header includes the Source Packet Header (SPH) timestamp. The SPH includes the lower 25 bits of the cycle counter and spans 8000 cycles. In one embodiment, 8000 cycles is approximately one second. The SPH is typically some absolute time in the future, based on the cycle timer.

When the applications are isochronous, two considerations of transporting time based data streams, such as the IEEE 1394-2000 isochronous data streams described herein, include bounded delay and guaranteed bandwidth. In these cases, the need to consider jitter is demonstrated to be unnecessary. When IEC 61883 compliant isochronous data streams are transported by RTP, all participating devices are, by definition, isochronous. Thus, the protocols used to manage network resources such that there is timely delivery (bounded maximum delay) of transported isochronous data streams is simplified because jitter is not a problem.

However, there is a need for receiving devices to accommodate the maximum delay in the sense that buffering is needed to accommodate the maximum delay. There is also a minimum delay associated with the flow of data. Thus, it can be conceptualized that the receiving devices experience an average jitter of 0.5 (maximum delay minus minimum delay) in the clock implied by the rate of delivery of packets on a non-isochronous transport. This will be discussed in greater detail below.

FIG. 6 illustrates a first embodiment of a real-time transfer protocol (RTP) packet format for an IEC 61883 compliant isochronous data stream. The RTP packet includes a version number (V), padding bit (P), an extension bit (X), a contributing source count (CC), a marker bit (M), a payload type (PT), a sequence number, a timestamp, a synchronization source (SSRC) identifier, a contributing source (CSRC) identifier, and IEC 61883 compliant isochronous data. In the first embodiment of the RTP packet, V is set to 2, P is set to 0, X is set to 0, CC is set to 1, and M is set to 0. The value of the payload type is set according to the RTP payload type for this packet format. It is expected that the RTP profile for a particular class of applications will assign a payload type for this encoding, or if that is not done, then a payload type in the dynamic range can be chosen by means of an out of band signaling protocol, such as Universal Plug and Play (UPnP). The sequence number is incremented by the number of isochronous cycles in the RTP data packet, starting, for security reasons, with a random initial value. The timestamp is the value of the isochronous cycle start transaction corresponding to the receipt of the first isochronous packet included in the RTP packet. The SSRC identifier corresponds to the high order 32 bits of the source's sixty-four (64) bit enhanced unique identifier value (EUI64). The CSRC identifier corresponds to the low order 32 bits of the sources EUI64. The IEC 61883 compliant isochronous data corresponds to the content of the isochronous channels for this session. The format of this IEC 61883 compliant isochronous data is described in detail below.

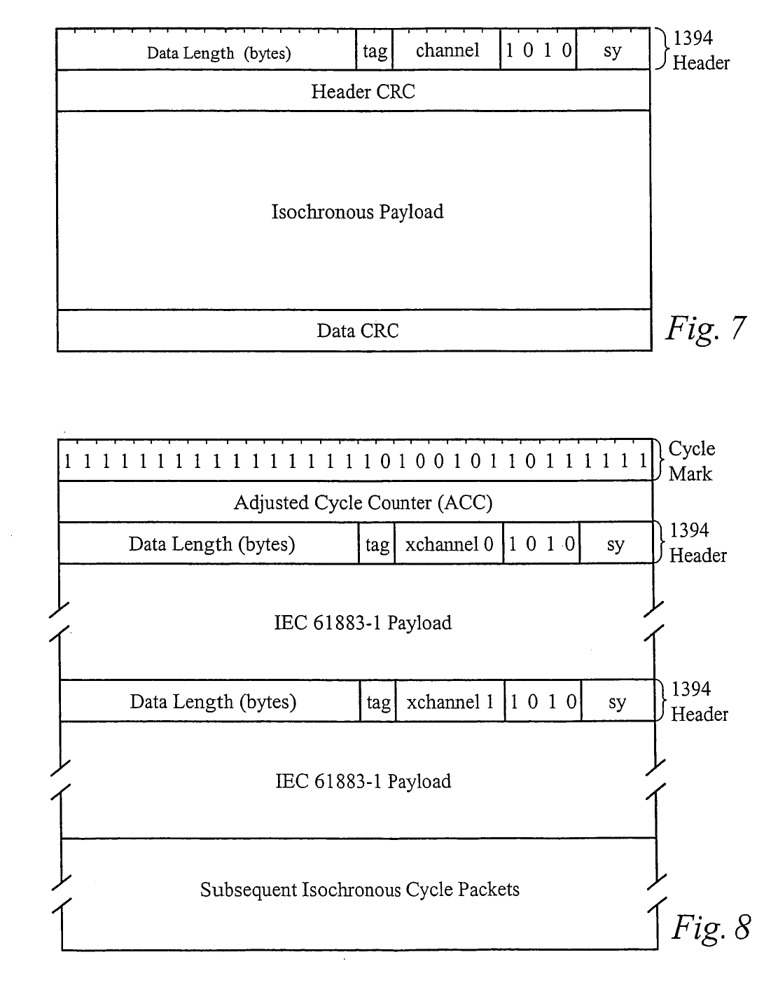

FIG. 7 illustrates a first embodiment of an isochronous data packet format. The isochronous packet format is also referred to as an IEEE 1394-2000 isochronous packet format. The isochronous packet includes an isochronous header, also referred to as an IEEE 1394-2000 header, a header CRC (Cyclical Redundancy Checking), isochronous payload, and data CRC. The isochronous header includes a data_length field, a tag field, a channel field, a tcode field, and a sy field. The data_length field is set to the size in bytes of the isochronous payload, not including the isochronous header. Isochronous packets which are IEC 61883 compliant, use the tag field to indicate the presence of CIP header quadlets. If the tag field is set to a value 00b, then no CIP header quadlets are present. If the tag field is set to a value 01b, then the CIP header quadlets are present. The channel field specifies the isochronous data channel for the packet. The tcode field specifies the packet format and the type of transaction that shall be performed, and in this case is set for isochronous data, indicated by 1010b. The sy field is an application-specific control field.

CRC is an error checking technique used to ensure the accuracy of transmitting digital data. The transmitted data is divided into predetermined lengths which, used as dividends, are divided by a fixed divisor. The remainder of the calculation is appended onto and sent with the data. At the receiving end, the computer recalculates the remainder. If it does not match the transmitted remainder, an error is detected. Typically, the CRCs are stripped by an IEEE 1394-2000 interface.

An isochronous cycle can include multiple packets, each packet occurring at most once for a channel. Thus a unit of information recorded for an isochronous cycle includes information about the cycle (cycle start) and information for each of the desired channels.

The information associated with an isochronous packet is combined with cycle start information to generate a cycle record for an isochronous cycle. Some of the fields within this cycle record are processed by the sending device to introduce a degree of independence from local conditions. FIG. 8 illustrates a first embodiment of a cycle record for a particular isochronous cycle. The record includes at least a cycle mark and an Adjusted Cycle Counter (ACC). The cycle mark is a constant value used for synchronization purposes. The ACC is the cycle counter that represents the isochronous cycle containing the subsequent isochronous packets. This cycle counter is derived from the cycle start packet, or from the local cycle counter. The ACC cycle count (and the cycle seconds) is 0 for the first cycle transmitted and is increased by one cycle per isochronous cycle. The cycle offset is recorded as received in the cycle start packet. If a missing cycle start causes synthesis of a cycle mark, the offset is captured from the local cycle counter.

The isochronous cycle record includes the cycle mark, the ACC, and the IEEE 1394-2000 header and IEC 61883 compliant payload for each channel transmitting data during the particular cycle associated with the isochronous cycle record. The example record of FIG. 8 illustrates that there is more than one IEC 61883 compliant data stream captured per isochronous cycle, as shown in the channel field, xchannel0 and xchannel1 in FIG. 8, of the IEEE 1394-2000 header. The value of the xchanneln field is mapped to the received IEEE 1394-2000 isochronous channel. This channel value identifies the IEEE 1394-2000 channel assigned to the isochronous payload for transmission purposes. As described above in relation to the isochronous data packet of FIG. 7, the tag field, the sy field, the tcode field (1010b in FIG. 7), and the IEC 61883 compliant payload are derived from the isochronous data packet.

RTP data packets using the payload format described above are subject to conventional security considerations. This implies that confidentiality of the data streams is achieved by encryption. Because the data compression used with this payload format is applied end-to-end, encryption is performed after compression so there is no conflict between the two operations.

A potential denial-of-service threat exists for data encoded using compression techniques that have non-uniform receiver-end computational load. The attacker can inject pathological datagrams into the data stream which are complex to decode and which cause the receiver to be overloaded. However, this encoding does not exhibit any significant non-uniformity.

In operation, within an isochronous compliant network, one or more data streams are packetized into isochronous data packets, which are then encapsulated for transmission over a non-isochronous compliant network. The isochronous data packets are grouped into cycle records. A cycle record is then bundled into one or more RTP data packets according to a real-time transport protocol. The real-time transport protocol provides for a header, which includes timing information derived from the isochronous compliant network, from which the one or more data streams originate. Network devices included within the isochronous compliant network are not aware that the isochronous data packets are transmitted over a non-isochronous compliant network. Included within the isochronous data packets are control commands formatted according to the isochronous compliant network. When the isochronous data packets are encapsulated for transmission over the non-isochronous compliant network, the control commands formatted according to the isochronous compliant network are also included. As such, network devices send isochronous data packets from a first isochronous compliant network to network devices within a second isochronous compliant network as if the first and second isochronous compliant networks are directly coupled, or are coupled via one or more other isochronous compliant networks. In this manner, network devices in the first isochronous compliant network are able to discover network devices in the second isochronous compliant network.

In a first embodiment, the isochronous compliant network is an IEEE 1394-2000 compliant network, and the non-isochronous compliant network is a non-IEEE 1394-2000 network. In this first embodiment, network devices included within the IEEE 1394-2000 compliant network are IEEE 1394-2000 compliant network devices. Using a device discovery protocol according to the IEEE 1394-2000 standard, an IEEE 1394-2000 compliant network device in a first IEEE 1394-2000 compliant network discovers IEEE 1394-2000 compliant network devices included within a second IEEE 1394-2000 compliant network, where the first and second IEEE 1394-2000 compliant networks are coupled via a non-IEEE 1394-2000 compliant network. The device discovery communications are encapsulated with the isochronous data packets according to the real-time transport protocol.

The present invention has been described in terms of specific embodiments incorporating details to facilitate the understanding of principles of construction and operation of the invention. Such reference herein to specific embodiments and details thereof is not intended to limit the scope of the claims appended hereto. It will be apparent to those skilled in the art that modifications may be made in the embodiment chosen for illustration without departing from the spirit and scope of the invention.

1. A method of communicating data streams, the method comprising:
a. packetizing one or more data streams into isochronous data packets;
b. encapsulating one or more isochronous data packets according to a real-time transport protocol to form a real-time transport protocol data packet; and
c. sending the real-time transport protocol data packets from a transmitting device to a receiving device over a non-isochronous compliant network.

2. The method of claim 1 wherein the transmitting device is coupled to a first isochronous compliant network and the receiving device is coupled to a second isochronous compliant network.

3. The method of claim 2 wherein the first isochronous compliant network and the second isochronous compliant network each comprise an IEEE 1394 compliant bus architecture.

4. The method of claim 3 wherein the first isochronous compliant network and the second isochronous compliant network are coupled via the non-isochronous compliant network.

5. The method of claim 4 wherein the non-isochronous compliant network comprises an Internet Protocol network.

6. The method of claim 5 wherein the Internet Protocol network comprises an Ethernet/Internet Protocol network.

7. The method of claim 2 further comprising generating a cycle record for each isochronous cycle of the first isochronous compliant network, wherein each cycle record includes a relative timing marker that indicates a timing of the real-time transport protocol data packet relative to the cycle master of the first isochronous compliant network.

8. The method of claim 1 wherein the real-time transport protocol defines a real-time transport protocol header and a real-time transport protocol data payload for each real-time transport protocol data packet.

9. The method of claim 8 wherein the real-time transport protocol data payload comprises one or more isochronous cycle records.

10. The method of claim 9 wherein each of the one or more isochronous cycle records comprises zero or more isochronous data packets.

11. The method of claim 10 wherein each isochronous data packet comprises an IEEE 1394 isochronous data packet.

12. The method of claim 11 wherein each IEEE 1394 isochronous data packet includes an IEEE 1394 data payload formatted according to an IEC 61883-1 compliant Common Isochronous Protocol (CIP).

13. The method of claim 8 wherein the real-time transport protocol header includes a timestamp, the timestamp is defined by a value of the isochronous cycle start transaction corresponding to the receipt of a first isochronous data packet included in a particular real-time transport protocol data packet.

14. The method of claim 1 wherein each real-time transport protocol data packet includes at least a portion of an isochronous cycle record.

15. An apparatus for communicating data streams, the apparatus comprising:
a. means for packetizing one or more data streams into isochronous data packets;
b. means for encapsulating one or more isochronous data packets according to a real-time transport protocol to form a real-time transport protocol data packet; and
c. means for sending the real-time transport protocol data packets from a transmitting device to a receiving device over a non-isochronous compliant network.

16. The apparatus of claim 15 wherein the transmitting device is coupled to a first isochronous compliant network and the receiving device is coupled to a second isochronous compliant network.

17. The apparatus of claim 16 wherein the first isochronous compliant network and the second isochronous compliant network each comprise an IEEE 1394 compliant bus architecture.

18. The apparatus of claim 17 wherein the first isochronous compliant network and the second isochronous compliant network are coupled via the non-isochronous compliant network.

19. The apparatus of claim 18 wherein the non-isochronous compliant network comprises an Internet Protocol network.

20. The apparatus of claim 19 wherein the Internet Protocol network comprises an Ethernet/Internet Protocol network.

21. The apparatus of claim 16 further comprising means for generating a cycle record for each isochronous cycle of the first isochronous compliant network, wherein each cycle record includes a relative timing marker that indicates a timing of the real-time transport protocol data packet relative to the cycle master of the first isochronous compliant network.

22. The apparatus of claim 15 wherein the real-time transport protocol defines a real-time transport protocol header and a real-time transport protocol data payload for each real-time transport protocol data packet.

23. The apparatus of claim 23 wherein the real-time transport protocol data payload comprises one or more isochronous cycle records.

24. The apparatus of claim 23 wherein each of the one or more isochronous cycle records comprises zero or more isochronous data packets.

25. The apparatus of claim 24 wherein each isochronous data packet comprises an IEEE 1394 isochronous data packet.

26. The apparatus of claim 25 wherein each IEEE 1394 isochronous data packet includes an IEEE 1394 data payload formatted according to an IEC 61883-1 compliant Common Isochronous Protocol (CIP).

27. The apparatus of claim 22 wherein the real-time transport protocol header includes a timestamp, the timestamp is defined by a value of the isochronous cycle start transaction corresponding to the receipt of a first isochronous data packet included in a particular real-time transport protocol data packet.

28. The apparatus of claim 22 wherein each real-time transport protocol data packet includes at least a portion of an isochronous cycle record.

29. An apparatus to communicate data streams, the apparatus comprising:
a. a transmitting circuit configured to encapsulate one or more first isochronous data packets according to a real-time transport protocol, thereby forming a first real-time transport protocol data packet, and to transmit the first real-time transport protocol data packets over a non-isochronous compliant network; and
b. a receiving circuit configured to receive a second real-time transport protocol data packet from the non-isochronous compliant network, and to de-encapsulate the received second real-time transport protocol data packets into one or more second isochronous data packets.

30. The apparatus of claim 29 wherein the transmitting circuit and the receiving circuit are each coupled to an isochronous compliant network.

31. The apparatus of claim 30 wherein the isochronous compliant network comprises an IEEE 1394 compliant bus architecture.

32. The apparatus of claim 29 wherein the real-time transport protocol defines a real-time transport protocol header and a real-time transport protocol data payload for each real-time transport protocol data packet.

33. The apparatus of claim 32 wherein the real-time transport protocol data payload comprises one or more isochronous cycle records.

34. The apparatus of claim 31 wherein each of the one or more isochronous cycle records comprises zero or more isochronous data packets.

35. The apparatus of claim 33 wherein each isochronous data packet comprises an IEEE 1394 isochronous data packet.

36. The apparatus of claim 35 wherein each IEEE 1394 isochronous data packet includes an IEEE 1394 data payload formatted according to an IEC 61883-1 compliant Common Isochronous Protocol (CIP).

37. The apparatus of claim 32 wherein the real-time transport protocol header includes a timestamp, the timestamp is defined by a value of the isochronous cycle start transaction corresponding to the receipt of a first isochronous data packet included in a particular real-time transport protocol data packet.

38. The apparatus of claim 29 wherein the transmitting circuit is further configured to packetize one or more data streams into the one or more isochronous data packets.

39. The apparatus of claim 29 wherein the transmitting circuit is further configured to receive the one or more isochronous data packets from another device.

40. The apparatus of claim 29 wherein the receiving circuit is further configured to parse the one or more isochronous data packets from each received real-time transport protocol data packet.

41. The apparatus of claim 40 wherein each received real-time transport protocol data packet includes at least a portion of an isochronous cycle record.

42. The apparatus of claim 41 wherein each isochronous cycle record comprises zero or more isochronous data packets.

43. A network of devices to communicate data streams, the network of devices comprising:
a. a transmitting device configured to encapsulate one or more isochronous data packets according to a real-time transport protocol, thereby forming a real-time transport protocol data packet, and to transmit the real-time transport protocol data packets;
b. a first isochronous compliant network coupled to the transmitting device;
c. a receiving device configured to receive the real-time transport protocol data packets;
d. a second isochronous compliant network coupled to the receiving device; and
e. a non-isochronous compliant network coupled to the first isochronous compliant network and the second isochronous compliant network to transmit the real-time transport protocol data packets from the transmitting device to the receiving device.

44. The network of devices of claim 43 wherein the first isochronous compliant network and the second isochronous compliant network each comprise an IEEE 1394 compliant bus architecture.

45. The network of devices of claim 43 wherein the non-isochronous compliant network comprises an Internet Protocol network.

46. The network of devices of claim 45 wherein the Internet Protocol network comprises an Ethernet/Internet Protocol network.

47. The network of devices of claim 43 wherein the real-time transport protocol defines a real-time transport protocol header and a real-time transport protocol data payload for each real-time transport protocol data packet.

48. The network of devices of claim 47 wherein the real-time transport protocol data payload comprises one or more isochronous cycle records.

49. The network of devices of claim 48 wherein each of the one or more isochronous cycle records comprises zero or more isochronous data packets.

50. The network of devices of claim 48 wherein each isochronous data packet comprises an IEEE 1394 isochronous data packet.

51. The network of devices of claim 50 wherein each IEEE 1394 isochronous data packet includes an IEEE 1394 data payload formatted according to an IEC 61883-1 compliant Common Isochronous Protocol (CIP).

52. The network of devices of claim 47 wherein the real-time transport protocol header includes a timestamp, the timestamp is defined by a value of the isochronous cycle start transaction corresponding to the receipt of a first isochronous data packet included in a particular real-time transport protocol data packet.

53. The network of devices of claim 43 wherein the transmitting device is further configured to packetize one or more data streams into the one or more isochronous data packets.

54. The network of devices of claim 43 wherein the transmitting device is further configured to receive the one or more isochronous data packets from another device.

55. The network of devices of claim 43 wherein the receiving device is further configured to parse the one or more isochronous data packets from each received real-time transport protocol data packet.

56. The network of devices of claim 55 wherein each received real-time transport protocol data packet includes at least a portion of an isochronous cycle record.

57. The network of devices of claim 56 wherein each isochronous cycle record comprises zero or more isochronous data packets.

58. A method of communicating data streams, the method comprising:
a. packetizing one or more data streams into IEEE 1394 compliant isochronous data packets;
b. encapsulating one or more IEEE 1394 compliant isochronous data packets according to a real-time transport protocol to form a real-time transport protocol data packet; and
c. sending the real-time transport protocol data packets from a transmitting device to a receiving device over a non-isochronous compliant network.

59. The method of claim 58 wherein the transmitting device is coupled to a first IEEE 1394 compliant bus architecture and the receiving device is coupled to a second IEEE 1394 compliant bus architecture.

60. The method of claim 59 wherein the non-isochronous compliant network comprises an Internet Protocol network.

61. The method of claim 60 wherein the Internet Protocol network comprises an Ethernet/Internet Protocol network.

62. The method of claim 59 further comprising generating a cycle record for each isochronous cycle of the first IEEE 1394 compliant bus architecture, wherein each cycle record includes a relative timing marker that indicates a timing of the real-time transport protocol data packet relative to the cycle master of the first IEEE 1394 compliant bus architecture.

63. The method of claim 58 wherein the real-time transport protocol defines a real-time transport protocol header and a real-time transport protocol data payload for each real-time transport protocol data packet.

64. The method of claim 63 wherein the real-time transport protocol data payload comprises one or more 1394 compliant isochronous cycle records.

65. The method of claim 64 wherein each of the one or more isochronous cycle records comprises zero or more isochronous data packets.

66. The method of claim 65 wherein each IEEE 1394 isochronous data packet includes an IEEE 1394 data payload formatted according to an IEC 61883-1 compliant Common Isochronous Protocol (CIP).

67. The method of claim 58 wherein the real-time transport protocol header includes a timestamp, the timestamp is defined by a value of the isochronous cycle start transaction corresponding to the receipt of a first 1394 compliant isochronous data packet included in a particular real-time transport protocol data packet.

68. The method of claim 58 further comprising parsing the one or more IEEE 1394 compliant isochronous data packets from each real-time transport protocol data packet received by the receiving device.

69. The method of claim 58 wherein each real-time transport protocol data packet includes at least a portion of an isochronous cycle record.
